(19) United States
(12) Patent Application Publication
(10) Pub. No.: US 2018/0182171 A1
(43) Pub. Date: Jun. 28, 2018

(54) Systems and Methods for Real-time Multimedia Augmented Reality

(71) Applicant: Drawsta, Inc., Los Angeles, CA (US)

(72) Inventor: Heather Lipner, Los Angeles, CA (US)

(21) Appl. No.: 15/390,712

(22) Filed: Dec. 26, 2016

(51) Int. Cl. G06T 19/00; G06T 7/20; G06T 7/70

(52) U.S. Cl. CPC G06T 19/006; G06T 7/20; G06T 7/13; G06T 2215/16; G06T 2207/30244; G06T 7/70

(57) ABSTRACT

Systems and methods for rendering multimedia overlays in real-time augmented reality. The augmented reality system relates to image targets used for mapping virtual object overlays in either a semantic or non-semantic context in real-time projection when coupled with an electronic device having augmented reality software, a server, and an integrated image capture device. Target points are seamlessly integrated into a decorative image target that may have a tessellated pattern, charm, drawing, photograph, or other image comprising of an arrangement of tracking points and pixels. Augmented reality software and a server combined with an image capture device on an electronic device detect tracking and target points in an image target and then project multimedia virtual object overlays that may be customized and are not limited to a semantic context.

### FIELD OF THE DISCLOSURE

The present disclosure relates to systems and methods for rendering multimedia overlays in real-time augmented reality. More specifically, the system described herein relates to image targets used for mapping virtual object overlays in either a semantic or non-semantic context in real-time projection when coupled with an electronic device having augmented reality software and an integrated image capture device.

### BACKGROUND

In augmented reality (“AR”), a computer incorporates additional virtual information into a user's view of the real world. The user can interact with the real world in a natural way while the computer provides graphical information that enhances the scene.

While it is possible to add objects without concern for the real world surrounding the user, most AR experiences require a precise alignment between virtual objects and the real environment so that the scene is as realistic as possible.

A core requirement for aligning virtual objects with physical objects in real-time is the ability to quickly define key features within the environment, such as corners or edges. These features are marked as points that can be tracked throughout their movement in a scene.

The tracking points are extracted and snapped to the physical objects through various mapping techniques. Changes in the viewer's position or the movement of objects within the scene will also moves the mapped virtual objects (i.e. shift, turn or rotate) such that the object maintains a realistic position, size and shape within the physical scene. Additionally, physical interactions between objects such as kinematic constraints, collision detection and response, and expected physical responses to external forces can also add to the sense of realism. Additionally, if desired, a user may be able to manipulate virtual objects, such as zooming out to see an overview or zooming in to see more detail.

Extracting tracking points “on-the-fly” for scenes viewed in real time wherein the objects in the scene are previously unknown demands high computational power. Calculating tracking points for objects within a scene before viewing the scene in real time can lower computational requirements, thus enhancing accuracy and performance for AR application on platforms with limited computational resources, such as mobile phones or Tablet PCs.

The majority of AR Application use a camera as the sensor for viewing the real world scene to which virtual objects will be mapped. The camera sensor's technical specifications, such as its field of view, resolution, or low light performance, place constraints on the ability detect and track objects. Choosing physical objects that are clearly defined, taking into account criteria, such as the technical specifications of the camera sensor, the mapping, tracking and detection techniques used by the AR application, or the computing power of the AR electronic device, will impact the accuracy and realism of the AR scene.

A popular AR application and overlay is Snapchat that uses filters and lenses to augment self-portraits commonly known as “selfies.” In the Snapchat software application, a photograph or video is captured first. Then a filter with an overlay design or text is selected. Then the design or text overlay is augmented onto the photograph or video. The resulting photo or video may then be saved.

Snapchat has limitations. First, the augmented overlays are limited to a semantic context. For example, the overlays are coordinated to complement facial feature. The overlays augment the eyes, nose, mouth, ears, and forehead. The Snapchat application recognizes facial features generally as image targets and applies an overlay to complement that target such as overlaying a crown of flowers on a person's forehead. Another drawback is tracking is limited by distance. There is reduced accuracy in overlaying an augmented object because the image targets do not have specific points for an image capture device to detect and “lock on” to and follow precisely. Therefore, an object can be augmented based on facial feature recognition, but the ability for a camera's targeting and tracking of facial feature movement still lacks accuracy and precision. The Snapchat software application is designed to work with facial features in a photograph or video taken an arm's length away. A face must be recognized within a designated screen area. Augmented animations are triggered by facial movement in a semantic context only. Another drawback is the use of facial features as the image targets and the resulting lack of accuracy and precision is the augmented object overlay is limited due to sensitivity to lighting and contrast. Therefore, movement that triggers the animations cannot be properly tracked, so the augmented object overlay fails.

### SUMMARY

What is needed is an augmented reality system with increased image target detection and tracking for the overlay of virtual objects in a non-semantic context where an electronic device coupled with augmented reality software in communication with a server and an image capture device that can be used at a distance greater than three feet away from the image target.

The present invention provides systems and methods for overlaying multimedia virtual object content onto an image target against a surface of a physical object in real time when generated and viewed via an electronic device containing augmented reality software, a server, and an image capture device. The system comprises at least one surface coupled with at least one image target and an electronic device coupled with augmented reality software, image capture device, and server, wherein the image target is comprised of an arrangement of pixel clusters having tracking points on pixel cluster edges and target points. The electronic device coupled with augmented reality software, image capture device, and server capable of detecting target points on pixel clusters on an image target simultaneously overlay a projected augmented virtual object over the image target as viewed on an electronic device.

Tracking points are calculated for one or more image targets using an augmented reality application software development kit, which are stored within an augmented reality library. One or more animations are mapped to the image target's target points that are recognized and stored within the augmented reality library. The image targets are either integrated in or with a surface in the physical world. Within the software application, a user may choose one or more of the stored virtual objects from the augmented reality library. A user may create and customize his/her own image target, writing, animation, or virtual object. A customized virtual object may contain multimedia content or text. A customized virtual object may be prefabricated and stored in a library on a server and may be shared with other users.

The user points the camera sensor of an electronic device at a physical scene containing one or more of the image targets, which when viewed through the display of the software application will augment the physical scene to include an overlay of the virtual object. The virtual object will maintain its orientation, position, and size relative to the image target, in real time.

In one embodiment, a wearable augmented reality image target capable of being targeted and tracked by an electronic device comprises augmented reality software in communication with a remote server and an image capture device at a distance from about 1 to about 12 feet away from the image target. The image target is present on a non-solid, non-static surface. The electronic device is capable of overlaying a virtual object in a non-semantic context onto the wearable image target. The image target is capable of accommodating a virtual object of a non-semantic context.

An exemplary method for augmenting, in real time, a virtual object for a non-semantic context onto a surface having an image target at a distance greater than three feet away from an electronic device involves the steps of prefabricating at least one virtual object, saving the virtual object in a library on the server, providing a surface having an image target, providing an electronic device having augmented reality software in communication with a server and an image capture device, aiming the image capture device to the image target, selecting a virtual object from the library, detecting target and tracking points on the image target, overlaying the selected virtual object to the surface having an image target, and capturing the resulting augmented multimedia of the virtual object overlaid onto the surface having an image target.

### BRIEF DESCRIPTION OF THE DRAWINGS

FIG. 1 illustrates an exemplary electronic device coupled with augmented reality software application, server (not shown), and image capture device in generating an augmented virtual object.

FIG. 2 illustrates an exemplary image target in the form of a decorative symbol comprising an arrangement of pixels with pixel p.

FIG. 3A illustrates an exemplary tessellated arrangement of pixels on a surface with a close-up of tracking points presented about the edges of a pixelated cluster.

FIGS. 3B and 3C illustrate an exemplary electronic device aimed at an image target having pixel clusters with tracking points.

FIG. 4 illustrates an electronic device with an image capture device sensor aimed at an image target.

FIGS. 5A and 5B illustrate an electronic device with an image capture device sensor aimed at an image target with target points.

FIG. 6 illustrates an exemplary image target comprising pixels with unnoticeable tracking points and image target points on a surface in the form of a t-shirt providing high contrast.

FIG. 7 illustrates an exemplary image target in the form of a temporary tattoo on a person's hand with a virtual object overlaid in a non-semantic context.

FIG. 8 illustrates exemplary method steps for providing augmented reality in a non-semantic context.

### DETAILED DESCRIPTION

The present invention provides systems and methods for overlaying multimedia virtual object content onto an image target against a surface of a physical object in real time when generated and viewed via an electronic device containing augmented reality software and a an image capture device.

Tracking points are calculated for one or more image targets using an augmented reality application software development kit, which are stored within an augmented reality library. One or more animations are mapped to the image target's target points that are recognized and stored within the augmented reality library. The image targets are either integrated in or with a surface in the physical world. A user may choose one or more of the stored virtual objects from the augmented reality library. The user points the camera sensor of an electronic device at a physical scene containing one or more of the image targets, which when viewed through the display of the software application will augment the physical scene to include an overlay of the virtual object. The virtual object will maintain its orientation, position, and size relative to the image target, in real time.

A user can view a real world scene captured by the camera sensor and displayed through the AR application on the display screen of a mobile smart phone or other electronic device such as desktop computers, laptops, tablets, goggles, eyeglasses, headsets, lenses, digital camera apparatuses, or smart watches.

When the AR application detects a stored image target objects within the camera sensor's field of view, the virtual object will be added to the physical scene as displayed by the AR application, in real time. The virtual object will maintain a position relative to a surface with the affixed image target while within the camera sensor view. Changes in position of the image target within the physical three dimensional space or the perceived change in position due to the changes in position of the camera sensor will result in the AR software application adjusting the virtual position, size or orientation of the virtual animated object to maintain its position relative to the image target within the sensor view. If more than a single stored image target is detected in a scene, the user will choose one or more virtual objects and which image target each virtual object should be mapped onto. The virtual object overlaid onto the image target may be done so in a non-semantic context.

The augmented reality scene can be viewed in real time or added into previously recorded content. The resulting AR experience can be recorded in a multiple of common video formats, such as mp4, for later viewing. The recorded content with at least one virtual object may comprise multimedia including photographs, drawings, sound, animations, video, and combinations thereof.

In the following sections, detailed descriptions of examples and methods of the disclosure will be given. The description of both preferred and alternative examples are exemplary only, and it is understood that to those skilled in the art that variations, modifications, and alterations may be apparent. It is therefore to be understood that the examples do not limit the broadness of the aspects of the underlying disclosure as defined by the claims.

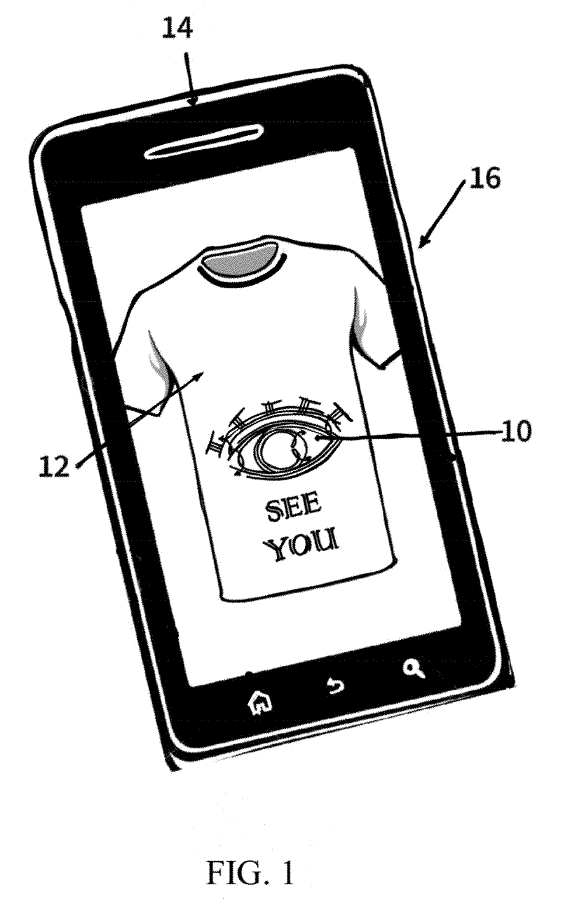

FIG. 1 shows an image target 10 which is affixed to a surface 12. Image targets 10 represent images that the software application can detect and track. Image targets are preferred because they do not need special black and white regions or codes to be recognized, such as those found in QR codes. In the current embodiment, a camera sensor 14 captures a physical scene containing an image target 10 and displays it on an electronic device 16. In order for the AR application to recognize and track the image target 10 as it moves within the displayed physical scene, an AR application detects distinctive features within the image target, assigns each feature a tracking point and stores the image target tracking data for retrieval.

In a preferred embodiment, the image target is loaded into an AR development application (SDK), which is used to detect distinctive features and assign tracking points within the image target.

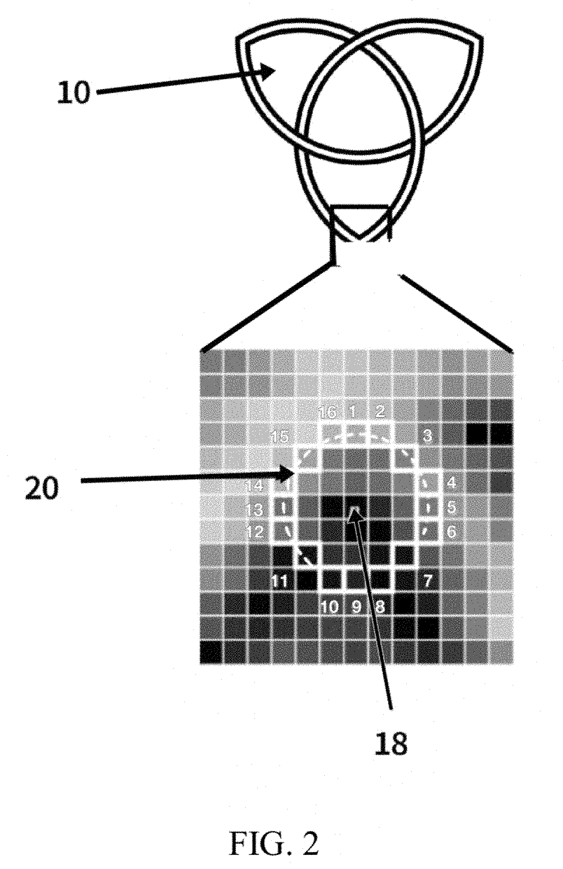

FIG. 2. shows a tracking point detection method. The current embodiment uses the Vuforia SDK by PTC, Inc. for AR image target detection and tracking, although other AR applications are contemplated. In some embodiments, the AR software implemented preferably utilizes an AR camera that allows for the detection and tracking of target points 24 or 26 that is integrated into an image target 10. The AR camera settings can be configured by a user or preset by an AR software developer or application builder.

An image target 10 is loaded into the AR SDK. In the current embodiment the FAST (Features from Accelerated Segment Test) corner detection algorithm is used for calculate tracking points in an image target, although other tracking point detection methods are contemplated. FAST looks for corners in the image target as features for which it will assign tracking points by analyzing the contrast between pixels in the image target 10.

Contrast is the scale of difference between black and white in the image target. The greater the contrast ratio, the greater the difference between the brightness and darkness. For example, black images against a white background will have a contrast ratio of 21:1, dark purple images against a white background will have a contrast ratio of 17.7:1.2, and dark red images against a white background will have a contrast ratio of 13:1.6. The inverse (a white image target on a black surface) may also be suitable. On the other hand, the contrast ratio for yellow images against a white background has a low contrast ratio of 1.1:19.6 that would not be suitable for augmented reality image target detection and tracking.

In some embodiments, relative pixel density may improve tracking of target points. For example, the target image may contain an average pixel density of 201 to 275 pixels per square inch, but pixel clusters 20 at target points may contain a pixel density of 800 to 900 pixels per square inch. Pixel densities of the overall target image and of the pixel clusters at target points may range from 200 to 2000 pixels per square inch.

In some embodiments, vectors rather than pixels may be used. Relative contrasts and linear irregularities may improve tracking. For example, the overall target image may be made up of a series of tessellated or repeated pixel or vector patterns. However, non-tessellated or irregular vectors or pixels differing from the surrounding vectors or pixels may provide improved target points for tracking. Irregularities may include sigmoid vectors, broken vectors, angled vectors, and relative thickness variance.

First, a user or automated function within the AR SDK chooses a threshold value t for the preferred contrast. The image target is scanned to calculate the luminance I_{ρ} of each pixel ρ 18. A circle of pixels or pixel cluster 20 around pixel ρ 18 are tested for their luminance in relation to the luminance of pixel ρ 16.

The pixel ρ 18 is a corner if there exists a set of n contiguous pixels in the circle of pixels 20, which are all brighter than I_{ρ}+t, or all darker than I_{ρ}−t.

A variation to increase test speed examines only the four pixels. If pixel ρ 18 is a corner, then at least three of these must all be brighter than I_{ρ}+t or darker than I_{ρ}−t. If neither of these is the case, then pixel ρ 18 cannot be a corner.

Additional machine learning algorithms can be applied for even greater accuracy. (See Edward Rosten, Reid Porter, and Tom Drummond, “Faster and better: a machine learning approach to corner detection” in IEEE Trans. Pattern Analysis and Machine Intelligence, 2010, vol 32, pp. 105-119.)

Each corner of a pixel cluster 20 detected is assigned a tracking point 22. At least one tracking point 22 must be present in the image target and may or may not be visible or noticeable to the human eye. Preferably, the image target 10 is a charm, graphic, photograph, symbol, tessellation, or any other pattern or visual that appears to be decorative in nature.

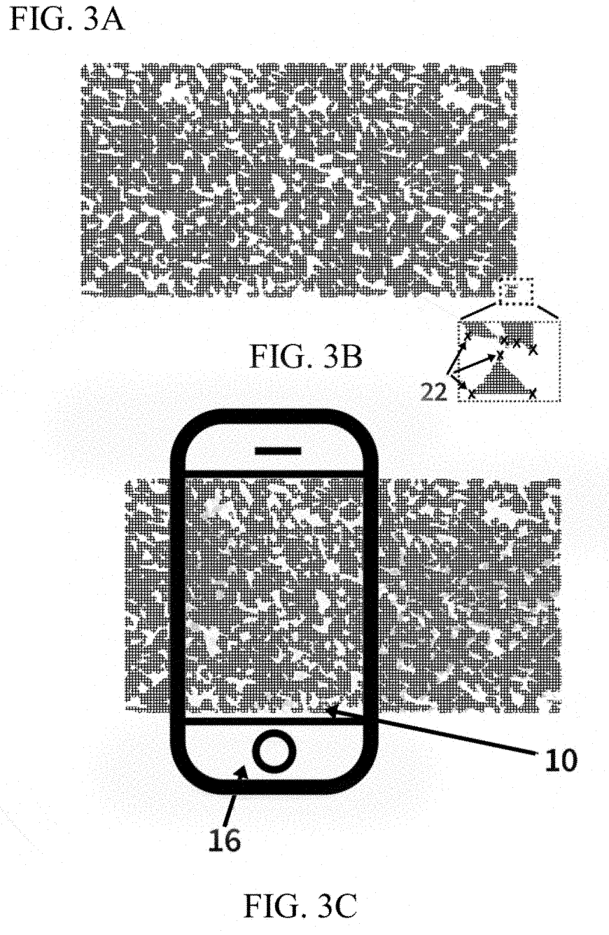

In the present invention, an image target 10 containing a balanced distribution of high-contrast features will be tracked more accurately than images with unbalanced or grouped high-contrast features. FIG. 3A shows an image target 10 with a balanced distribution of high contrast features. FIG. 3B indicates a subset of image target 10 with a series of tracking points 22 assigned to the high contrast corners. Each corner detected in this high contrast image will be assigned a tracking point. Even distribution allows consistent tracking regardless of the percentage of the image target is within the cameras sensor range. FIG. 3C shows a portion of the image target 10 as displayed on electronic device 16. The high number of balanced high contrast features allows for numerous detectable tracking points for the AR application to detect and track when only a portion of the image target is available to the camera sensor view.

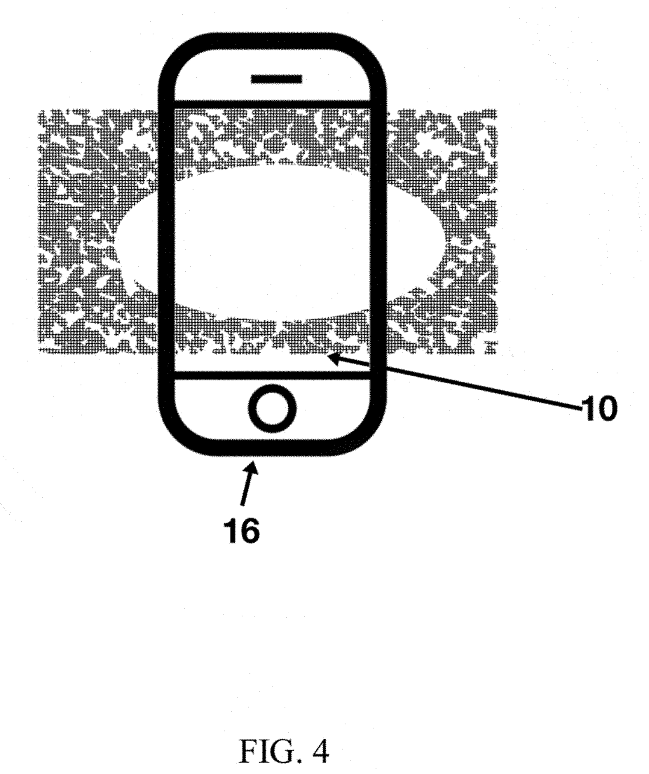

FIG. 4 shows an image target 10 containing an unbalanced distribution of high contrast features. In this view, there are less high contrast corners, and thus less tracking points available when the image target 10 is partially available from the camera sensor 14 and displayed on the electronic device 16 than for the image target 10 shown in FIG. 3B. Less available target points for the AR application to track reduces tracking accuracy of the image target 10 as it moves with the planar object to which it is affixed within the three-dimensional physical space captured by the camera sensor 14.

Therefore, in the preferred embodiment, selecting or assigning an image target with a sufficient number of high-contrast features with a balanced distribution across the image target will improve virtual object overlay and tracking. An example of providing an image target with a sufficient number of high-contrast features is an item of clothing such as a t-shirt or an accessory such as a baseball cap of a light color such as white and with a graphic target image printed thereon in black.

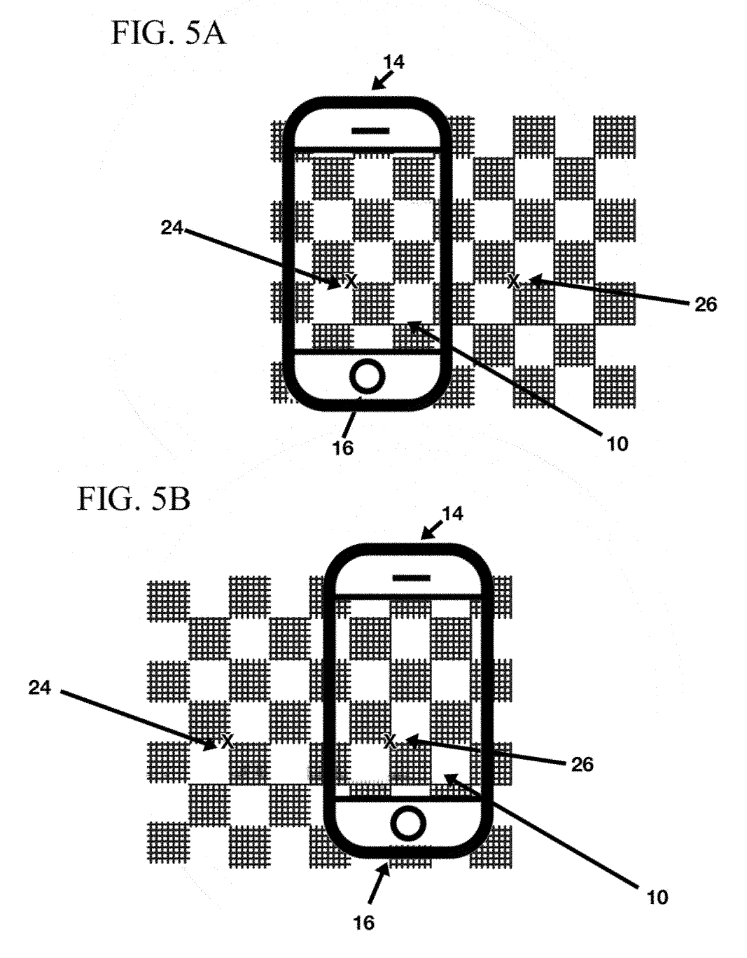

FIG. 5 shows an image target 10 with repetitive pattern and rotational symmetry. Image targets 10 with repetitive patterns or with a rotation symmetry may interfere with detection and tracking accuracy and performance. FIG. 5A shows a checkerboard pattern image target 10 with a portion being in the field of view of the camera sensor 14 being displayed on the electronic device 16. Two target points 24 and 26 are shown with target marker 24 seen through the camera sensor and target point 26 outside of the camera sensor field of view. FIG. 5B shows the same checkerboard pattern image target 10 with a different portion than in FIG. 5A being in the field of view of the camera sensor 14 being displayed on the electronic device 16. From the perspective of the camera sensor 14, both views are identical. For the views show in FIG. 5A and FIG. 5B, the AR application could inaccurately assign target points, which would result in inaccurate tracking of the image target 10

Additionally, the checkerboard pattern has strong rotational symmetry wherein rotating the pattern around its center point will appear identical at various degrees. The checkerboard pattern shown in FIGS. 5A and 5B has a rotational symmetry order 4 wherein there are four positions at which the current pattern looks identical. Therefore, at any given angle of rotation from the perspective of the camera sensor has at least four identical positions, three of which would be incorrect resulting in an inaccurate tracking of the image target.

Adding a virtual object to the image target uses a 3D rendering engine, which can add 2D or 3D virtual objects into the physical scene captured by the camera sensor. The current embodiment uses Unity3D, a cross platform rendering engine that can interface with Vuforia using the image target data from the device or cloud database.

Adding a virtual object to the physical scene requires the virtual object be matched to the image target. The virtual object can be still or be in motion, such as a video. The virtual object can be two-dimensional or three-dimensional. The virtual object may last from about 1 to about 30 seconds, especially for videos and animations. In some embodiments, such virtual object may be pre-programmed to continue on a loop.

In a preferred embodiment, the virtual object is prefabricated and stored by using the AR rendering engine to position and size the animated virtual object to the image target. The size parameter ensures that the information returned during live tracking will match the scale and position of the virtual object to the image target in the virtual scene. The matching coordinate data is stored within the AR application on the electronic device 16.

In one embodiment, the AR Application on the electronic device 16 contains a library of virtual objects that have been previously mapped, to the target points of a multiple of image targets also stored in the AR software application or available through cloud storage. A remote server such as a cloud, solid state, or hard drive based server or a network-attached storage may host the virtual object library and store virtual objects therein.

The camera sensor is used to capture a live view of a physical world scene and displayed on the electronic device 16 or a server using the AR software application. The system described herein eliminates the traditional three-step process of first capturing an image, then selecting an overlay, and finally generating an augmented photograph or video clip that may be saved.

One or more image targets are affixed to the surface of an object in the physical world, such as a shirt or other type of clothing. A user may choose a virtual object from within the AR application on the electronic device, or the projected virtual object may be random or pre-determined by the AR application or at the time the virtual object is created and loaded into the AR application virtual object library. A user points the camera sensor toward an area in the physical world containing the image target.

When a camera sensor recognizes an image target, it matches that image target against the reference target stored in the AR software application, locating the tracking points in the reference image and matching them to the image target captured by the camera sensor. The reference target may be a target point 24 that may be within a camera's field of view or be a target point that is outside 26 as shown in FIG. 5a. One or more virtual objects are added to the scene at the position and size determined during the prefabrication.

As mentioned previously, accuracy of the virtual object placement and its matching and tracking to the image target is dependent upon the recognition of tracking points in the image target by the image capture device sensor. The increased contrast provided by the image target against a surface increases the distance and tracking accuracy by which the AR software generates the virtual object overlay. The distance for detecting and tracking an image target may be from about 1 to 12 feet away in some embodiments.

The ability for the image capture device sensor to detect and track tracking points on the image target in the physical world is dependent upon the technical specifications of the image capture device sensor, including factors such as, but not limited to, ambient light levels, quality of the lens and CMOS chip type. An image capture device may be a digital still-shot or video camera or a combination still-shot and video camera capable of capturing multimedia with outputs of .jpg, .gif, .png, .tif, mp4, RAW, or .avi for example. The image capture device may be coupled with a separate or integrated microphone with or without speakers for sound capture and playback.

For example, United States Patent US20150172574A1 for a “Solid-state imaging device, driving method of solid-state imaging device, and electronic apparatus” details a solid-state imaging device that drives pixels at a high speed with reduced pixel blurring, allowing for sharper details in electronic device camera. The iPhone 6S uses Sony Corporations Exmor RS camera sensor based on the IMX230 sensor chip, which is known for its high signal-to-noise ratio (SNR) in low light. Spikes in luminance charge on light receiving pixels within the camera sensor will create image noise. SNR is the proportion between the noise and the average luminosity of the image area containing the noise. Therefore, the higher the camera sensor's signal to noise ratio, SNR can be expressed as the arithmetic mean or average luminosity divided by the amount of noise (Standard Deviation). SNR=Mean_pixel_Luminosity/StdDev_pixel_Luminosity which is often expressed in decimals where SNR_dB=20·log 10(SNR)=log 10(Mean Noise). A lower SNR will increase accuracy of the FAST corner detection and tracking of the image target. As SNR increases, so does the ability for the camera sensor to resolve details in lower light, or where tracking points are based on lower contrast corners, or a combination thereof. Therefore, in the current embodiment, increasing ambient light intensity will increase FAST corner detection and tracking accuracy, until the maximum signal to noise ratio is achieved, which can also be expressed as the square root of the maximum saturation capacity for any given light receiving pixel on the camera sensor.

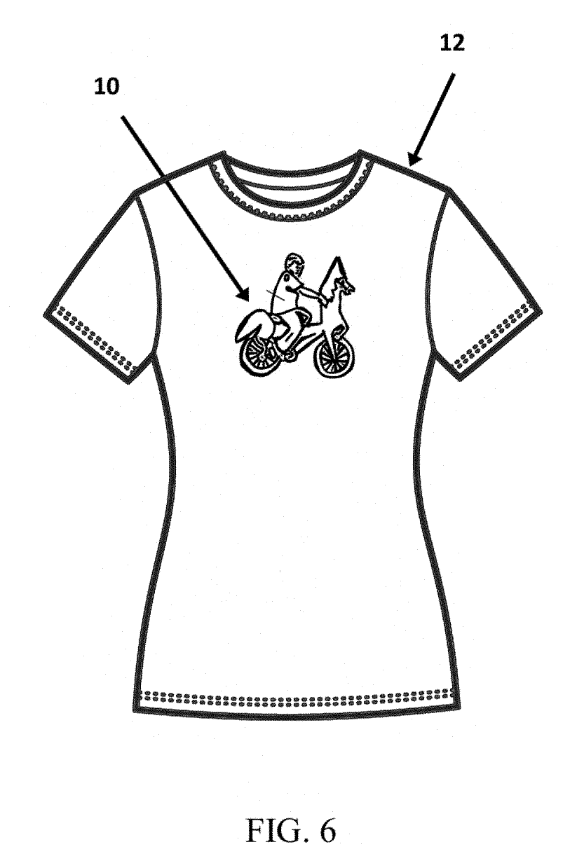

Referring now to FIG. 6, an exemplary image target comprising pixels with unnoticeable tracking points and image target points on a surface in the form of a t-shirt providing high contrast is illustrated. The surface 12 is a plain t-shirt with an image target 10. The image target 10 is a print or decal of a person riding a bicycle, and the bicycle has a horse head figure with a cone hat on the top. The image target 10 is made up of pixel clusters that have tracking and target points (not shown) that are not readily identifiable or noticeable to the human eye. The t-shirt is a non-solid, non-static surface meaning that the surface is malleable, foldable, or bendable. The surface 12 is in contrast to a flat, rigid surface or static surface.

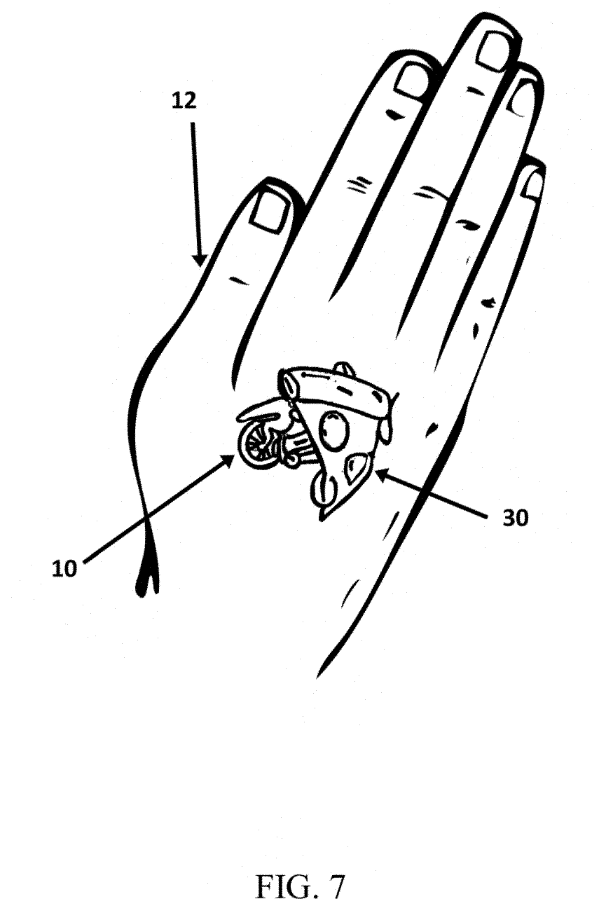

Although the augmented reality system will function when the image target is on a solid, rigid surface such as a book, storage container, sheet of paper, furniture, wall, or any other solid surface, the augmented reality system will still be just as effective on an imperfect and malleable surface such as a t-shirt that folds and moves along with the person wearing the t-shirt. A single t-shirt can provide for the overlay of many virtual objects 30 (shown in FIG. 7) and reduces waste and can still be washable. A wearable surface furthermore is not limited to a t-shirt and may be in the form of any wearable item of clothing such as scarves, jackets, pants, glasses, jewelry, stickers, charms, and pendants.

Referring now to FIG. 7, an exemplary image target in the form of a temporary tattoo on a person's hand with a virtual object overlaid in a non-semantic context is illustrated. Here, the image target 10 is the same one as the image target in FIG. 7. The only difference is that instead of being a screen print on a t-shirt, that same graphic was applied to a person's hand via a temporary tattoo. Therefore, the surface 12 is a hand. The virtual object 30 that is overlaid is a pizza which has no contextual relation to the person riding a bike as in the image target 10. The image target 10 can serve as the “placeholder” for tracking and target points (22, 24, and 26 not visible in this figure) for a variety of virtual objects 30. In addition to a tattoo, an image target 10 may be present on drinkware, party favors, toys, promotional items, glasses, magnets, or car decals as examples that are non-limiting.

The pizza graphic of the virtual object 30 may be animated, have text, change color, and be classified under different categories of virtual objects 30 in a library (not shown). Examples of categories of virtual objects 30 are random and in-real-life. There may be packages available based on a category. In that case, several different virtual objects 30 may replay on a loop and may last up to about 30 seconds, or longer in some instances, each or may be changed on command via the augmented reality software.

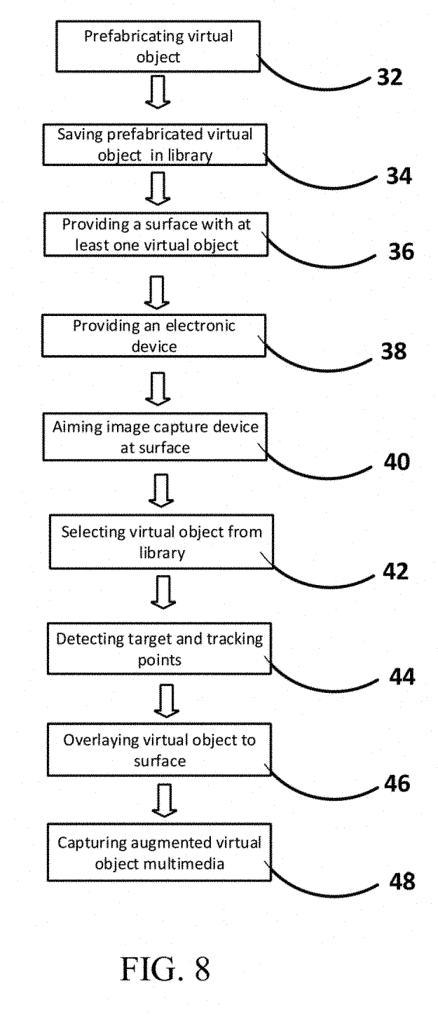

Referring now to FIG. 8, exemplary method steps for providing augmented reality in a non-semantic context is illustrated. In real time, a virtual object for a non-semantic context may be overlaid onto a surface having an image target at a distance greater than three feet away from an electronic device. In many embodiments, the process involves the steps of prefabricating at least one virtual object 32, saving the virtual object in a library on the server 34, providing a surface having an image target 36, providing an electronic device having augmented reality software in communication with a server and an image capture device 38, aiming the image capture device to the image target 40, selecting a virtual object from the library 42, detecting target and tracking points on the image target 44, overlaying the selected virtual object to the surface having an image target 46, and capturing the resulting augmented multimedia of the virtual object overlaid onto the surface having an image target 48.

In some embodiments, the image capture device by way of using the augmented reality software can be used to adjust the software setting for color, duration, brightness, contrast, or any other factor relevant to augmenting a virtual object onto a surface having at least one image target. The augmented reality software on the electronic device can also be used to calibrate the detection of target points and tracking of tracking points while the surface with the target image is in motion. This allows for increased movement of the surface and/or of the person aiming the electronic device without disruption in the overlay of the augmented virtual object. The resulting multimedia captured in a photograph, video, or even sound file of any available file format such as mp4, mp3, .jpg, .gif, or .tif for example can be saved to the serve for future reference or for sharing digitally such as on social media. The process allows for customized yet flexible advertising or expression of views or of self in an efficient manner that reduces waste and is not limited to a semantic context or limited by contrast, distance, movement, or image quality issues.

Several embodiments of the present disclosure have been described. While this specification contains many specific implementation details, there should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. Nevertheless, it will be understood that various modifications may be made without departing from the spirit and scope of the claimed disclosure.

What is claimed is:

1. A system for generating real-time augmented reality in a non-semantic context, the system comprising
at least one surface coupled with at least one image target and
an electronic device coupled with augmented reality software, image capture device, and server,
wherein the image target is comprised of an arrangement of pixel clusters having tracking points on pixel cluster edges and target points,
wherein the electronic device coupled with augmented reality software, image capture device, and server are capable of detecting target points on pixel clusters on an image target and simultaneously overlaying a projected augmented virtual object over the image target as viewed on the electronic device.

2. The system of claim 1 wherein the electronic device is a smart phone, smart watch, goggles, headset, glasses, desktop computer, laptop, or tablet.

3. The system of claim 1 wherein the surface is a wearable item of clothing or an accessory.

4. The system of claim 3 wherein the item of clothing or accessory is washable.

5. The system of claim 1 wherein the surface is a non-wearable item.

6. The system of claim 5 wherein the non-wearable item is a three-dimensional object.

7. The system of claim 5 wherein the non-wearable item is a two-dimensional object.

8. The system of claim 1 wherein the surface is skin.

9. The system of claim 1 wherein the image target is a temporary tattoo or an adhesive sticker.

10. The system of claim 1 wherein the image target is a charm, pendant, or sticker.

11. The system of claim 1 wherein the image target is a decal or a print.

12. The system of claim 1 wherein the virtual object is an animation, text, video, sound, static image, or combination thereof.

13. The virtual object of claim 12 capable of lasting from about 1 to about 30 seconds.

14. A wearable augmented reality image target capable of being targeted and tracked by an electronic device comprising augmented reality software in communication with a remote server and an image capture device,
from a distance between 1 and 12 feet,
wherein the image target is present on a non-solid, non-static surface,
the image target comprises pixel clusters with tracking and target points integrated in a graphic design on the wearable non-solid, non-static surface,
and whereby the electronic device is capable of overlaying a virtual object in a non-semantic context onto the wearable image target,
and the wearable image target is capable of accommodating a virtual object of a non-semantic context.

15. The wearable augmented reality image target of claim 14 wherein the non-solid, non-static surface is a shirt, blouse, sweater, or jacket.

16. The wearable augmented reality image target of claim 15 having a contrast ratio from about 13:1.6 to about 21:1 or its inverse.

17. A method for augmenting, in real time, a virtual object of a non-semantic context onto a surface having an image target at a distance greater than three feet away from an electronic device having augmented reality software in communication with a remote server and an image capture device, the method steps comprising
prefabricating at least one virtual object,
saving the prefabricated virtual object in a library on the server,
providing a surface having an image target,
providing an electronic device having augmented reality software in communication with a server and an image capture device,
aiming the image capture device of the electronic device to the surface having an image target,
selecting a virtual object from the library,
detecting target and tracking points on the image target,
overlaying the selected virtual object to the surface having an image target, and
capturing the resulting augmented multimedia of the virtual object overlaid onto the surface having an image target.

18. The method of claim 17 further comprising the method step of adjusting the image capture device or the augmented reality software settings for color, duration, brightness, and contrast.

19. The method of claim 17 further comprising the method step of calibrating the detection of target points and tracking of tracking points while the surface with the target image is in motion.

20. The method of claim 17 further comprising the method step of saving the resulting augmented multimedia to the server.
